(19) United States
(12) Patent Application Publication
(10) Pub. No.: US 2024/0250277 A1
(43) Pub. Date: Jul. 25, 2024

(54) SEPARATOR FOR FUEL CELL

(71) Applicant: TOYOTA BOSHOKU KABUSHIKI KAISHA, Aichi-ken (JP)

(72) Inventor: Haruyuki AONO, Aichi-ken (JP)

(73) Assignee: TOYOTA BOSHOKU KABUSHIKI KAISHA, Aichi-ken (JP)

(21) Appl. No.: 18/410,264

(22) Filed: Jan. 11, 2024

(30) Foreign Application Priority Data
Jan. 23, 2023 (JP) 2023-007993

(51) Int. Cl. H01M 8/026; H01M 8/0267

(52) U.S. Cl. CPC H01M 8/026; H01M 8/0267

(57) ABSTRACT

A separator for a fuel cell includes multiple gas passages arranged side by side on a facing surface, and multiple cooling passages provided on a cooling surface. Each cooling passage is located between adjacent ones of the gas passages. The gas passages include multiple upstream passages arranged side by side, a merging portion, and a downstream passage that extends from the merging portion. The cooling surface includes a downstream end portion and a groove. The downstream end portion is a section in one of the cooling passages. The section is located between adjacent ones of the upstream passages and at an end portion of the cooling passage on a downstream side in a flow direction of the coolant. The groove connects the downstream end portion to another one of the cooling passages that is adjacent to the downstream end portion with one of the gas passages in between.

### BACKGROUND

### 1. Field

The present disclosure relates to a separator for a fuel cell.

### 2. Description of Related Art

Japanese Laid-Open Patent Publication No. 2008-108571 discloses a single cell for a fuel cell.

The single cell disclosed in the publication includes a power generating unit, an anode-side separator, and a cathode-side separator. The anode-side separator and the cathode-side separator are located on opposite sides of the power generating unit. The surface of the anode-side separator that is in contact with the power generating unit includes fuel gas passages through which fuel gas flows. The surface of the cathode-side separator that is in contact with the power generating unit includes oxidation gas passages through which oxidation gas flows. The cathode-side separator includes ribs between adjacent ones of the oxidation gas passages. The surface of each rib that is opposite to the surface in contact with the power generating unit includes a coolant groove passage through which coolant flows. The oxidation gas passages include a merging portion at which oxidation gas flowing through adjacent ones of the oxidation gas passages merges.

In a case in which a merging portion is provided for oxidation gas passages, the flow of coolant is blocked by the merging portion in a coolant groove passage located between adjacent ones of the oxidation gas passages. This may reduce the cooling efficiency of the separator.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a separator for a fuel cell includes multiple gas passages and multiple cooling passages. The gas passages are arranged side by side on a facing surface configured to face a power generating unit of the fuel cell. The gas passages are configured to allow reactant gas to flow through the gas passages. The cooling passages are provided on a cooling surface that is on a side opposite to the facing surface. Each cooling passage is located between adjacent ones of the gas passages and being configured to allow a coolant to flow through the cooling passage. An upstream side and a downstream side in a flow direction of the reactant gas in each gas passage are defined as an upstream side and a downstream side, respectively. The gas passages include multiple upstream passages arranged side by side, a merging portion that is configured such that the reactant gas flowing through at least two of the upstream passages merges at the merging portion, and a downstream passage that extends from the merging portion toward the downstream side. The cooling surface includes a downstream end portion and a groove. The downstream end portion is a section in one of the cooling passages. The section is located between adjacent ones of the upstream passages and at an end portion of the cooling passage on a downstream side in a flow direction of the coolant. The groove connects the downstream end portion to another one of the cooling passages that is adjacent to the downstream end portion with one of the gas passages in between.

Other features and aspects will be apparent from the following detailed description, the drawings, and the claims.

### BRIEF DESCRIPTION OF THE DRAWINGS

FIG. 1 is an exploded perspective view of a single cell according to one embodiment.

FIG. 2 is a plan view of a cathode-side separator shown in FIG. 1.

FIG. 3 is a perspective view mainly showing merging portions in gas passages shown in FIG. 2.

FIG. 4 is a cross-sectional view taken along line 4-4 of FIG. 3.

FIG. 5 is a cross-sectional view showing a protrusion according to a modification.

FIG. 6 is an enlarged plan view showing a cathode-side separator according to a first modification.

FIG. 7 is an enlarged plan view showing a cathode-side separator according to a second modification.

FIG. 8 is an enlarged plan view showing a cathode-side separator according to a third modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

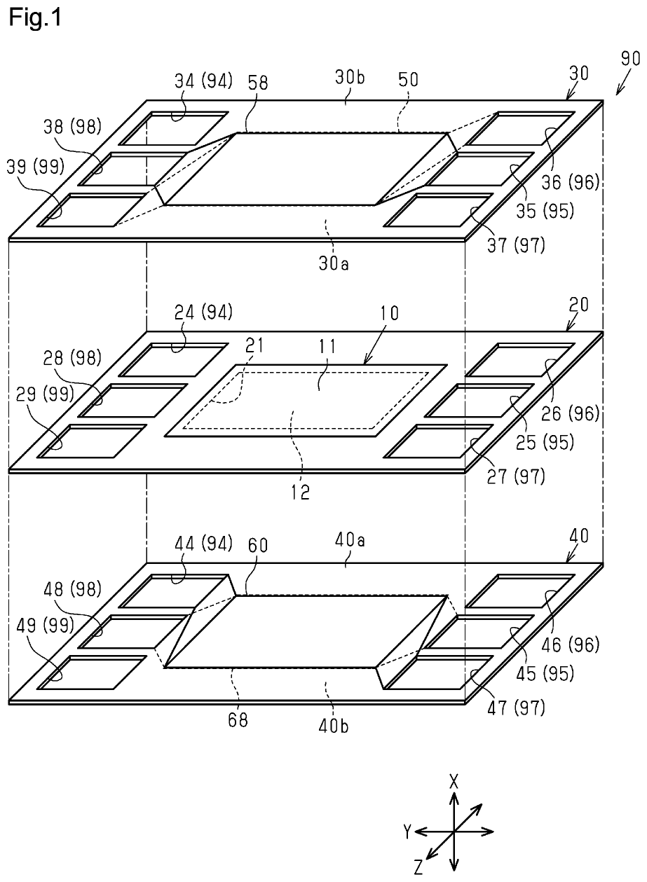

A separator for a fuel cell according to an embodiment will now be described with reference to FIGS. 1 to 4. For illustrative purposes, some parts of the structures in the drawings are exaggerated or simplified, and the dimensional ratios of the structures may be different from the actual ratios.

### Single Cell 90

As shown in FIG. 1, a single cell 90 for a fuel cell includes a membrane electrode gas diffusion layer assembly (hereinafter, referred to as a power generating unit 10), a frame member 20, which has an electrical insulation property and surrounds the power generating unit 10, a cathode-side separator 30, and an anode-side separator 40. The cathode-side separator 30 and the anode-side separator 40 hold the power generating unit 10 and the frame member 20 in between. The single cell 90 is a rectangular plate as a whole.

In the following description, the direction in which the cathode-side separator 30, the layer including the power generating unit 10 and the frame member 20, and the anode-side separator 40 are stacked will be referred to as a first direction X.

Also, the directions in which the long sides and the short sides of the single cell 90 extend will be respectively referred to as a second direction Y and a third direction Z.

The single cell 90 includes supply-side manifold holes 94, 95, 96 for introducing fuel gas, coolant, and oxidant gas into the single cell 90. Further, the single cell 90 includes discharge-side manifold holes 97, 98, 99 for discharging the fuel gas, the coolant, and the oxidant gas in the single cell 90 to the outside.

The supply-side manifold holes 94, 95, 96 and the discharge-side manifold holes 97, 98, 99 each extend in the first direction X through the single cell 90. The supply-side manifold hole 94 and the discharge-side manifold holes 98, 99 are provided on one side in the second direction Y of the single cell 90 (on the left side as viewed in FIG. 1). The discharge-side manifold hole 97 and the supply-side manifold holes 95, 96 are provided on the other side in the second direction Y of the single cell 90 (on the right side as viewed in FIG. 1). The supply-side manifold hole 94 and the discharge-side manifold holes 98, 99 are arranged in that order in the third direction Z while being spaced apart from each other. The discharge-side manifold hole 97 and the supply-side manifold holes 95, 96 are arranged in that order in the third direction Z while being spaced apart from each other.

### Power Generating Unit 10

As shown in FIG. 1, the power generating unit 10 includes a solid polymer electrolyte membrane (not shown; hereinafter referred to as an electrolyte membrane) and electrodes 11, 12 respectively provided on opposite surfaces of the electrolyte membrane. In the present embodiment, the electrode that is joined to one side in the first direction X (the upper side as viewed in FIG. 1) of the electrolyte membrane (not shown) is a cathode 11. Also, the electrode joined to the other side in the first direction X (the lower side in the in FIG. 1) of the electrolyte membrane is an anode 12. The electrodes 11, 12 each include a catalyst layer, which is joined to the electrolyte membrane, and a gas diffusion layer, which is joined to the catalyst layer.

### Frame Member 20

As shown in FIG. 1, the frame member 20 is provided between the cathode-side separator 30 and the anode-side separator 40. The frame member 20 is a substantially rectangular plate elongated in the second direction Y. The frame member 20 is made of, for example, a plastic.

The frame member 20 includes supply-side manifold holes 24, 25, 26 and discharge-side manifold holes 27, 28, 29, which are respectively parts of the supply-side manifold holes 94, 95, 96 and the discharge-side manifold holes 97, 98, 99.

The frame member 20 includes an opening 21 in a center. The periphery of the power generating unit 10 is joined to the inner edge of the opening 21 from one side in the first direction X (from the upper side as viewed in FIG. 1).

### Cathode-Side Separator 30

As shown in FIG. 1, the cathode-side separator 30 is arranged to face the cathode 11 of the power generating unit 10. The cathode-side separator 30 includes a metal base (e.g., stainless steel) and a conductive coating layer that covers the surface of the base. The base of the cathode-side separator 30 is formed by stamping.

The cathode-side separator 30 includes supply-side manifold holes 34, 35, 36 and discharge-side manifold holes 37, 38, 39, which are respectively parts of the supply-side manifold holes 94, 95, 96 and the discharge-side manifold holes 97, 98, 99.

The cathode-side separator 30 includes a facing surface 30a, which overlaps with the frame member 20 and the power generating unit 10, and a cooling surface 30b, which is a surface on a side opposite to the facing surface 30a.

The cathode-side separator 30 includes gas passages 50, through which oxidant gas flows, and cooling passages 58, through which coolant flows. The gas passages 50 are provided in the facing surface 30a. The cooling passages 58 are provided in the cooling surface 30b.

FIG. 1 illustrates, in a simplified manner, the outer edge of a section in the cathode-side separator 30 that includes the gas passages 50 and the outer edge of a section in the cathode-side separator 30 that includes the cooling passages 58.

### Anode-Side Separator 40

As shown in FIG. 1, the anode-side separator 40 is arranged to face the anode 12 of the power generating unit 10. The anode-side separator 40 includes a metal base (e.g., stainless steel) and a conductive coating layer that covers the surface of the base. The base of the anode-side separator 40 is formed by stamping.

The anode-side separator 40 includes supply-side manifold holes 44, 45, 46 and discharge-side manifold holes 47, 48, 49, which are respectively parts of the supply-side manifold holes 94, 95, 96 and the discharge-side manifold holes 97, 98, 99.

The anode-side separator 40 includes a facing surface 40a, which overlaps with the frame member 20 and the power generating unit 10, and a cooling surface 40b, which is a surface on a side opposite to the facing surface 40a.

The anode-side separator 40 includes gas passages 60, through which fuel gas flows, and cooling passages 68, through which coolant flows. The gas passages 60 are provided on the facing surface 40a. The cooling passages 68 are provided on the cooling surface 40b.

FIG. 1 illustrates, in a simplified manner, the outer edge of a section in the anode-side separator 40 that includes the gas passages 60 and the outer edge of a section in the anode-side separator 40 that includes the cooling passages 68.

The configuration of the cathode-side separator 30 will now be described.

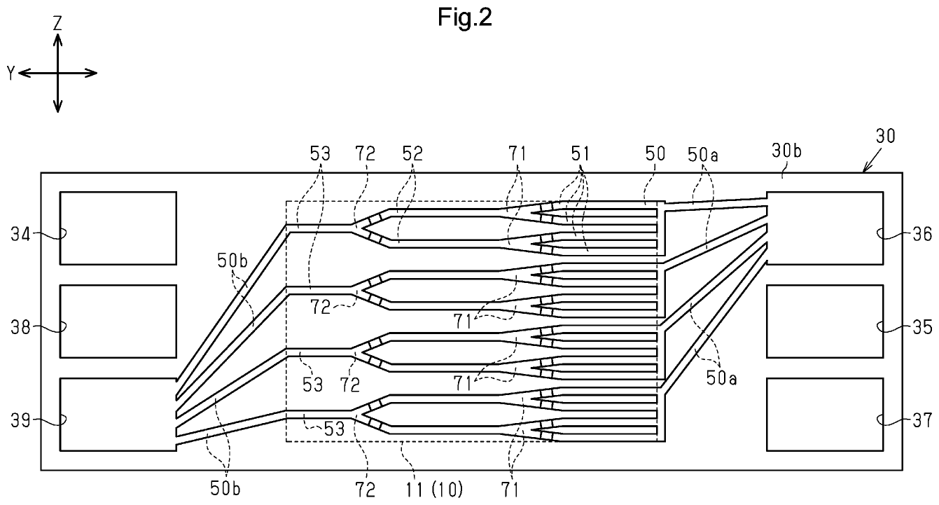

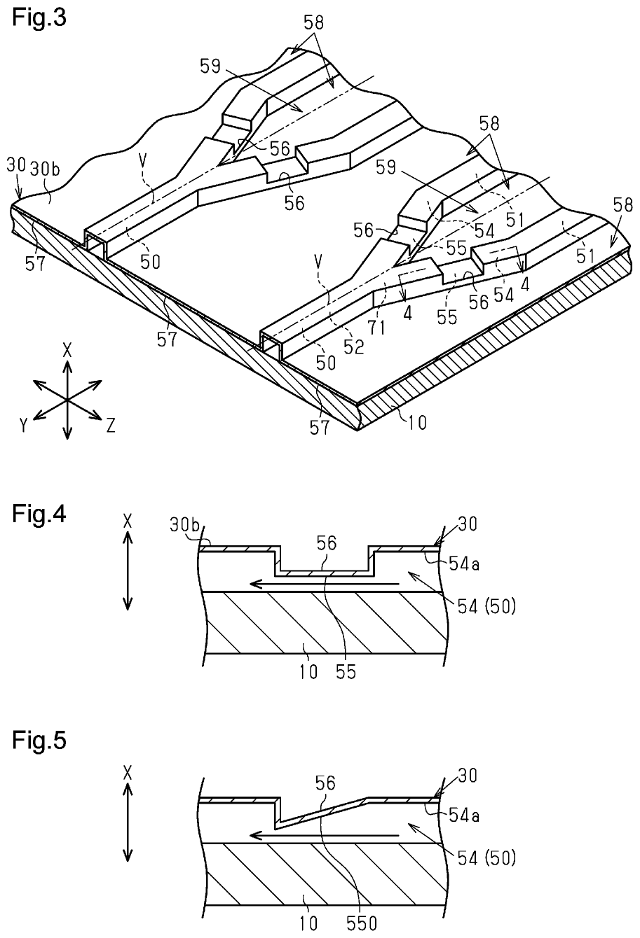

As shown in FIG. 2, the gas passages 50 connect the supply-side manifold hole 36 and the discharge-side manifold hole 39 to each other. Ribs 57 are provided between the gas passages 50 (see FIG. 3). Oxidant gas (reactant gas) is supplied to the gas passages 50 from the supply-side manifold hole 36. The oxidant gas flowing through the gas passages 50 is discharged to the discharge-side manifold hole 39. The width of each gas passage 50 is constant over the entire length of the gas passage 50.

In the following description, an upstream side and a downstream side in the flow direction of oxidant gas in the gas passages 50 will simply be referred to as an upstream side and a downstream side, respectively.

The gas passages 50 include, in order from the upstream side, supply-side connecting passages 50a, first passage sections 51, second passage sections 52, third passage sections 53, and discharge-side connecting passages 50b.

The first passage sections 51, the second passage sections 52, and the third passage sections 53 of the gas passages 50 face the cathode 11 of the power generating unit 10.

The supply-side connecting passages 50a connect the supply-side manifold hole 36 to the first passage sections 51. In the present embodiment, four supply-side connecting passages 50a are arranged side by side in the third direction Z.

The first passage sections 51 branch at the downstream side of each supply-side connecting passage 50a. The first passage sections 51 are arranged side by side. In the present embodiment, four first passage sections 51 branch from each supply-side connecting passage 50a and are arranged side by side in the third direction Z. The gas passages 50 also include first merging portions 71. The oxidant gas flowing through adjacent two of the four first passage sections 51 merges at one of the first merging portions 71. The second passage sections 52 each extend downstream from one of the first merging portions 71. In the present embodiment, two of the second passage sections 52 are connected to four of the first passage sections 51 via two of the first merging portions 71.

The gas passages 50 include second merging portions 72 and the third passage sections 53. The oxidant gas flowing through two of the second passage sections 52 merges with each other at one of the second merging portions 72. The third passage sections 53 extend downstream from the second merging portions 72. In the present embodiment, one of the third passage sections 53 is connected to two of the second passage sections 52 via one of the second merging portions 72.

The discharge-side connecting passages 50b connect the third passage sections 53 to the discharge-side manifold hole 39. In the present embodiment, four discharge-side connecting passages 50b are arranged side by side in the third direction Z.

In the relationship between the first passage sections 51 and the second passage sections 52, the first passage sections 51 correspond to upstream passages according to the present disclosure, and the second passage sections 52 correspond to downstream passages according to the present disclosure. Also, in the relationship between the second passage sections 52 and the third passage sections 53, the second passage sections 52 correspond to upstream passages according to the present disclosure, and the third passage sections 53 correspond to downstream passages according to the present disclosure.

As shown in FIG. 3, the cooling surface 30b of the cathode-side separator 30 includes cooling passages 58 each arranged between adjacent ones of the gas passages 50. Coolant flows through the cooling passages 58. The cooling surface 30b includes downstream end portions 59. Each downstream end portion 59 is a section in one of the cooling passages 58 that is located between adjacent ones of the first passage sections 51 and at a downstream end in the flow direction of coolant. Each downstream end portion 59 includes an axis V that extends linearly. The arrangement of the two first passage sections 51 that are adjacent to each downstream end portion 59 is symmetrical with respect to the axis V.

Each first passage section 51 includes a diagonal portion 54. The diagonal portions 54 of each pair of the first passage sections 51 that are adjacent to one of the downstream end portions 59 are diagonal with respect to the axis V such that the distance between the diagonal portions 54 decreases toward the first merging portion 71.

As shown in FIGS. 3 and 4, each diagonal portion 54 includes a protrusion 55 protruding toward the power generating unit 10. The protrusion 55 extends over the entire width of the diagonal portion 54.

The cooling surface 30b includes grooves 56 that connect each downstream end portion 59 to other cooling passages 58 that are adjacent to the downstream end portion 59 with the gas passages 50 in between. The grooves 56 are formed by the protrusions 55. The grooves 56 are provided in portions of the cooling surface 30b that are on the side opposite to two of the first passage sections 51 adjacent to the downstream end portion 59. Each groove 56 is provided in a portion of the cooling surface 30b that is on the side opposite to the corresponding diagonal portion 54.

As shown in FIG. 4, the protruding amount of each protrusion 55 from the bottom surface 54a of the diagonal portion 54 is constant in the extending direction of the diagonal portion 54.

The second passage sections 52 include protrusions 55 and grooves 56 in the same manner as the first passage sections 51.

Operation of the present embodiment will now be described.

As shown in FIG. 3, coolant that has flowed to the downstream end portion 59 of each cooling passage 58 flows to other cooling passages 58 via the grooves 56. This prevents the flow of coolant from being interrupted by the first merging portions 71.

The present embodiment has the following advantages.

(1) The cooling surface 30b includes the downstream end portions 59 and the grooves 56 that connect each downstream end portion 59 to other cooling passages 58 that are adjacent to the downstream end portion 59 with the gas passages 50 in between.

This configuration operates in the above-described manner and thus limits a decrease in the cooling efficiency of the cathode-side separator 30, while allowing the flows of oxidant gas to converge.

(2) The grooves 56 are provided in portions of the cooling surface 30b that are on the side opposite to two of the first passage sections 51 adjacent to the downstream end portion 59.

With this configuration, coolant that has flowed to the downstream end portion 59 of each cooling passage 58 flows to two of the cooling passages 58 adjacent to the downstream end portion 59 through the grooves 56, located in portions of the cooling surface 30b that are on the side opposite to the two first passage sections 51 adjacent to the downstream end portion 59. This prevents the flow of coolant from being uneven. This further limits the decrease in the cooling efficiency of the cathode-side separator 30.

(3) The arrangement of the two first passage sections 51 that are adjacent to each downstream end portion 59 is symmetrical with respect to the axis V.

This configuration prevents coolant from flowing unevenly to one of the cooling passages 58 when the coolant flows from each downstream end portion 59 to two of the cooling passages 58 adjacent to the downstream end portion 59. This prevents the cooling performance of the coolant from varying from position to position.

(4) Each first passage section 51 includes a diagonal portion 54. The diagonal portions 54 of each pair of the first passage sections 51 that are adjacent to one of the downstream end portions 59 are diagonal with respect to the axis V such that the distance between the diagonal portions 54 decreases toward the first merging portion 71. Each groove 56 is provided in a portion of the cooling surface 30b that is on the side opposite to the corresponding diagonal portion 54.

With this configuration, the coolant that has flowed to the downstream end portion 59 of each cooling passage 58 flows to other cooling passages 58 via the grooves 56, which are provided in portions of the cooling surface 30b on the side opposite to the diagonal portions 54. This allows the coolant to flow into the grooves 56 without significantly changing its flow direction. This prevents the coolant from being retained in the downstream end portion 59. This further improves the cooling efficiency of the cathode-side separator 30.

### Modifications

The above-described embodiment may be modified as follows. The above-described embodiment and the following modifications can be combined as long as the combined modifications remain technically consistent with each other.

As shown in FIG. 5, the protruding amount of a protrusion 550 may be increased toward the downstream side in the flow direction of oxidant gas. In this case, the protrusion 550 is inclined such that the protruding amount increases toward the downstream side. This limits an increase in the pressure loss of the oxidant gas due to the protrusion 550. This improves the power generation performance of the fuel cell.

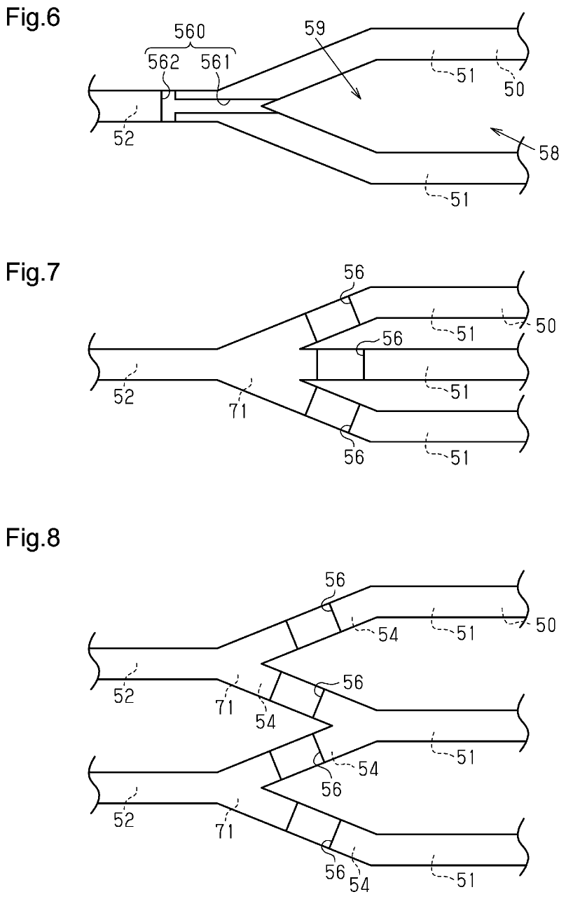

As shown in FIG. 6, a groove 560 may have a T-shape in plan view and include a first portion 561, which extends from the downstream end portion 59 in the extending direction of the second passage section 52, and a second portion 562, which extends from the first portion 561 in the width direction of the second passage section 52.

The arrangement of the first passage sections 51, which are adjacent to the downstream end 59, may be asymmetric with respect to the axis V.

In the above-described embodiment, the groove 56 may be omitted from one of the two first passage sections 51, which are adjacent to each downstream end 59.

The above-described embodiment describes a configuration in which each first merging portion 71 is provided for two of the first passage sections 51. However, as shown in FIG. 7, each first merging portion 71 may be provided for three of the first passage sections 51. In this case, each of the three first passage sections 51 may include a groove 56. Also, among the three first passage sections 51, only the two first passage section 51 on the opposite sides may include grooves 56, respectively.

As shown in FIG. 8, among three adjacent first passage sections 51, the central first passage section 51 may branch such that oxidant gas flowing through the central first passage section 51 merges with the oxidant gas flowing through the two adjacent first passage sections 51 on the opposite sides. The three first passage sections 51 include a total of four diagonal portions 54. In this case, each of the four diagonal portions 54 may have a groove 56. Also, for example, among the four diagonal portions 54, one of the central two diagonal portions 54 may include a groove 56.

In addition to or in place of the cathode-side separator 30, the present disclosure may be employed in the anode-side separator 40. In this case, the fuel gas corresponds to the reactant gas.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A separator for a fuel cell, comprising:
multiple gas passages arranged side by side on a facing surface configured to face a power generating unit of the fuel cell, the gas passages being configured to allow reactant gas to flow through the gas passages; and
multiple cooling passages provided on a cooling surface that is on a side opposite to the facing surface, each cooling passage being located between adjacent ones of the gas passages and being configured to allow a coolant to flow through the cooling passage, wherein
an upstream side and a downstream side in a flow direction of the reactant gas in each gas passage are defined as an upstream side and a downstream side, respectively,
the gas passages include:
multiple upstream passages arranged side by side;
a merging portion that is configured such that the reactant gas flowing through at least two of the upstream passages merges at the merging portion; and
a downstream passage that extends from the merging portion toward the downstream side, and
the cooling surface includes:
a downstream end portion, the downstream end portion being a section in one of the cooling passages, the section being located between adjacent ones of the upstream passages and at an end portion of the cooling passage on a downstream side in a flow direction of the coolant; and
a groove that connects the downstream end portion to another one of the cooling passages that is adjacent to the downstream end portion with one of the gas passages in between.

2. The separator for the fuel cell according to claim 1, wherein the groove is one of at least two grooves, the grooves being provided in portions of the cooling surface that are on a side opposite to two of the upstream passages adjacent to the downstream end portion.

3. The separator for the fuel cell according to claim 2, wherein
the downstream end portion includes an axis that extends linearly, and
the arrangement of two of the upstream passages that are adjacent to the downstream end portion is symmetrical with respect to the axis.

4. The separator for the fuel cell according to claim 1, wherein
the downstream end portion includes an axis that extends linearly,
two of the upstream passages that are adjacent to the downstream end portion respectively include diagonal portions, the diagonal portions being diagonal with respect to the axis such that the distance between the diagonal portions decreases toward the merging portion, and
the groove is provided in a portion of the cooling surface that is on a side opposite to each of the diagonal portions.

5. The separator for the fuel cell according to claim 1, wherein
the facing surface includes a protrusion in a portion of the facing surface that is on a side opposite to the portion in which the groove is provided, the protrusion protruding into the gas passage, and
the protrusion is inclined such that a protruding amount increases toward the downstream side.
